(19) United States
(12) Patent Application Publication
(10) Pub. No.: US 2006/0091666 A1
(43) Pub. Date: May 4, 2006

(54) Silent feature for an adjustable turning loop

(76) Inventors: David R. Amold, Macomb, MI (US); Robert J. Desmarals, Lake Orion, MI (US)

Correspondence Address: KEY SAFETY SYSTEMS, INC.;PATENT DEPARTMENT, 7000 NINETEEN MILE ROAD, STERLING HEIGHTS, MI, 48314, US

(21) Appl. No.: 11/266,996

(22) Filed: Nov. 4, 2005

Related U.S. Application Data
(60) Provisional application No. 60/625,006, filed on Nov. 4, 2004.

(51) Int. Cl. B60R 22/20

(52) U.S. Cl. 280/801.2; 280/808

(57) ABSTRACT

A height adjuster (100, 200, 400) for a seat belt system comprising a mounting bar (102, 202, 402), a carrier (120, 220, 460, 460a) and a spring-loaded locking lever (170, 270, 490). The mounting bar is preferably oval or rectangular in cross-section with at least one wall (side wall), which acts as an engagement or locking surface. The engagement surface can include a plurality of small teeth. The bar is adapted to be mounted to a support surface or structure. The carrier is slidably mounted on the bar and is movable to different positions. The carrier includes a main portion, which may be U-shaped in cross-section with a top, a bottom and a center wall. Each of the top and bottom walls includes a first opening through which the mounting bar extends. A friction force generator or friction enhancer pushes the lock lever laterally into a side of the mounting bar.

This application claims the benefit of U.S. Provisional Applications 60/625,006, filed on Nov. 4, 2004, 60/379,912, filed on May 13, 2002 and 60/430,254, filed on Dec. 2, 2002 and patent application Ser. No. 10/408,622, filed on Apr. 7, 2003, now U.S. Pat. No. 6,733,041. The disclosures of the above applications are incorporated herein by reference.

### BACKGROUND AND SUMMARY OF THE INVENTION

The present invention generally relates to a height-adjusting mechanism (height adjuster) for a D-ring (also called a web guide) of a seat belt system.

The shoulder belt 560 of a three-point seat belt system 562 is typically supported at or about shoulder level of the occupant by a web guide or D-ring 500 as generally illustrated in FIG. 12. The seat belt system also includes a seat belt retractor 561 operatively connected to the shoulder belt 560 and a lap belt 564 with a tongue 566, which is lockable within a buckle 568. The lap belt and buckle are appropriately anchored to the floor or seat frame. In some vehicles, the web guide is an integral part of the vehicle seat, while in others it is attached to one of the pillars (such as the B, C, or D-pillar) of the vehicle generally identified by numeral 570. The web guide or D-ring 550 is typically constructed to provide a support surface, formed as a slot, over which the shoulder belt slides and the web guide includes means for mounting the D-ring to the seat or pillar. D-rings may also include a decorative cover 572. U.S. Pat. No. 5,601,311 is illustrative of a simple web guide. It is now commonplace to mount the web guide on a vertically adjustable mechanism 574, which is typically called a height adjuster or an adjustable turning loop (ATL). U.S. Pat. Nos. 5,050,907 and 5,230,534 are illustrative of this type of adjustable mechanism and are incorporated herein by reference.

In most height adjusting mechanisms the D-ring is attached to a carrier. The carrier is manually moveable to a desired position by the occupant of the vehicle. The carrier often slides upon a rail or track and the carrier includes a lock or detent mechanism, which will lock or hold the carrier at the desired vertical location as chosen by the occupant. At the desired location, the shoulder belt crosses the occupant's body at a more comfortable location.

An inspection of many of the existing height adjusting mechanisms shows the use of a rail that is often a complex and expensive part, and made using many machining operations. Similarly, the carrier and locking mechanism are also relatively complicated mechanisms.

It is an object of the present invention to provide an improved height adjusting assembly.

Accordingly the invention comprises: a height adjuster for a seat belt system comprising a mounting bar, a carrier and a spring-loaded locking lever. The mounting bar is preferably oval or rectangular in cross-section with at least one wall (side wall), which acts as an engagement or locking surface. The engagement surface can include a plurality of small teeth. The bar is adapted to be mounted to a support surface or structure. The carrier is slidably mounted on the bar and is movable to different positions. The carrier includes a main portion, which may be U-shaped in cross-section with a top, a bottom and a center wall. Each of the top and bottom walls includes a first opening through which the mounting bar extends.

The spring-loaded locking lever (lock bar) is movable from a locking position in which it engages the engagement surface of the mounting bar to a free or unlocked position. The locking lever includes a base portion and a lever (activation lever) portion, which extends from the base portion at a pre-set angle. In one embodiment of the invention the carrier includes a side, which extends from a center wall of the carrier. The carrier can be configured to have a locking lever pivot slot at the top or bottom of the side or the pivot slot can be located in the center of the side. The locking lever is spring loaded and in one configuration the locking lever is spring loaded by a leaf spring and in another embodiment the locking lever is biased by a coil spring. The locking lever is slidingly mounted on the bar and includes a lock opening in the lever portion thereof. The mounting bar extends through the lock opening and the locking lever includes a first lock edge formed on a corner of the locking lever at the lock opening.

The locking lever is rotatable about the pivot slot between a free position and locked or locking position. The locking lever can be manually movable to the free position or can be moved using another force producing mechanism such as a solenoid. The spring urges the locking lever to its locked position. As can be appreciated another force producing mechanism can also be used to move the locking lever to the locked position. In other embodiments the lock lever includes a curved end, which wraps about and rotates relative to various portions of the carrier.

In one embodiment, the carrier further includes a bias force-generating mechanism such as a metal spring or elastomeric insert that laterally biases the lock lever into frictional engagement with a smooth side of the lock or mounting bar. Movement of the carrier in an upward direction causes the disengagement of the lock tooth on the lock lever to disengage from a lock tooth on the lock bar. The obvious benefit of this cooperation is the elimination or significant reduction of noise caused by the ratcheting of the lock lever on the teeth of the lock bar. The second benefit of a disengaging of the lock lever from the lock bar is a reduction in wear of these components. The lateral bias force always acts upon the lock lever, even when the lock lever is moved downwardly.

Many other objects and purposes of the invention will be clear from the following detailed description of the drawings.

### BRIEF DESCRIPTION OF THE DRAWINGS

FIG. 1 is a front isometric view of an adjustable web guide or D-ring using the present invention.

FIG. 2 is a rear isometric view of the device shown in FIG. 1.

FIGS. 3 and 3A-C show various views of a carrier assembly.

FIG. 4 is a rear plan view of the present invention.

FIG. 4A shows an enlarged view of the height adjuster in its locked position.

FIG. 4B shows a height adjuster in its unlocked condition.

FIG. 4C shows an enlarged view of an alternate embodiment of a height adjuster in its locked position.

FIG. 4D shows the height adjuster of FIG. 4C in its unlocked condition with the carrier being moved or urged upwardly.

FIG. 4E shows a spring associated with the embodiment in FIGS. 4C and 4D.

FIG. 5 is a top plan view of a locking lever.

FIG. 5A is a cross-sectional view of the locking lever.

FIG. 6 is a side plan view of the height adjuster.

FIG. 7 is a front plan view of the invention.

FIG. 7A is a rear isometric view of the height adjuster of FIG. 7.

FIG. 8 shows an alternate embodiment of the invention.

FIGS. 9, 9A and 9B show other embodiments of the invention.

FIG. 10 is a rear view of another embodiment of the invention.

FIG. 11 shows further details of a carrier and locking lever used in FIG. 10.

FIG. 12 shows a three-point seat belt system and a prior art height adjuster for a web guide (or D-ring).

### DETAILED DESCRIPTION OF THE DRAWINGS

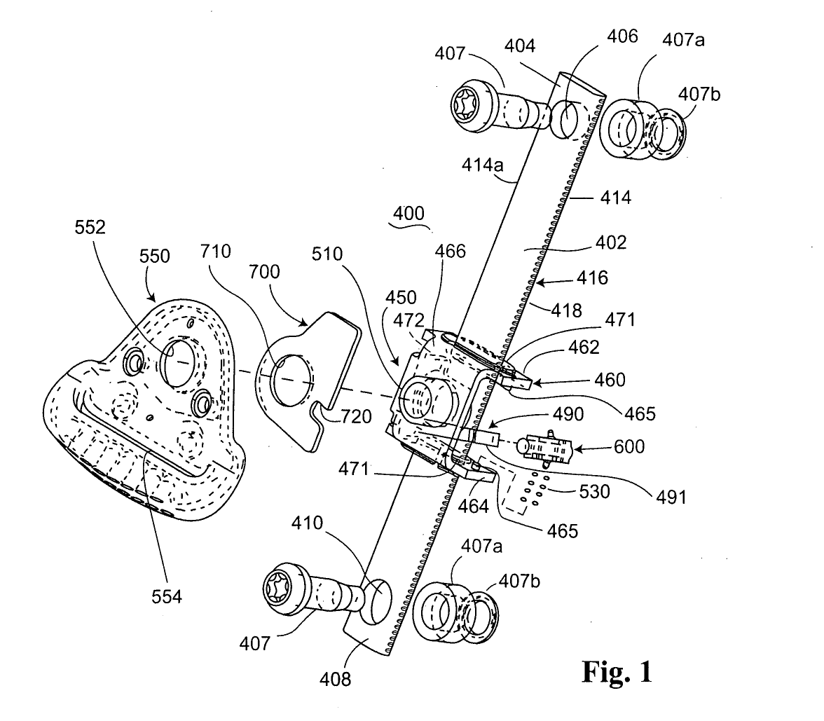

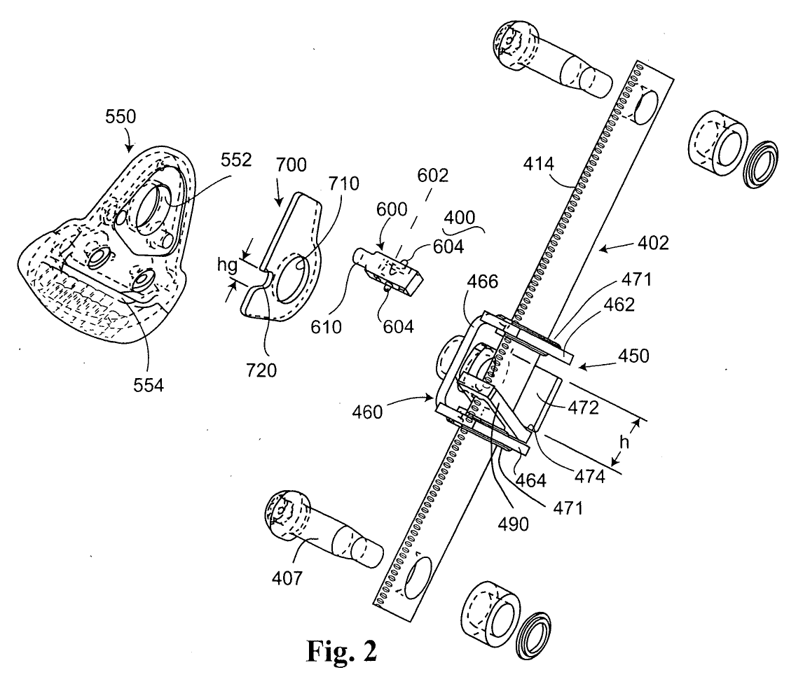

FIGS. 1 and 2 show front and rear views of a height adjuster 400 incorporating some aspects of the present invention. The height adjuster 400 includes a mounting bar 402 and a carrier assembly 450 and could also include mounting hardware to mount the bar to a vehicle. In the preferred embodiment of the invention the bar 402 is a heat treated steel, which is appropriately coated with a rust preventing agent. The bar is adapted to be mounted to a support surface such as to a portion of a vehicle (a support pillar) or to the frame of a vehicle seat.

By way of illustration, end 404 of bar 402 includes a mounting opening 406 and end 408 includes a mounting opening 410. A respective threaded bolt 407 is received within openings 406 and 410 and a spacer 407a can be used to easily space the rear of the height adjuster 400 from an adjacent mounting surface. A washer 407b can be placed between each spacer 407a and the mounting surface.

The mounting bar 402 includes at least one engagement or locking surface, which can be any of its four sides (front, rear, left side and right side). In this embodiment a first or primary locking surface is formed by the right side (side wall) 414. In the preferred embodiment side 414 includes a set of locking features 416 such as a plurality of vertically spaced teeth, grooves or indentations 418. These teeth are optional but when used increase the load capacity of the height adjuster. If used, the teeth 418 are closely spaced at for example an inter-tooth pitch of about 1-1.5 mm. One of the benefits of using the plurality of teeth is the high number of stable locking positions is significantly more than found in the prior art. The opposite side 414a of the bar can be smooth but can also include a second plurality of teeth (not shown). The included angle between adjacent surfaces of each tooth 418 is approximately 120 degrees. The included angle may be in the range of about 90-120 degrees.

In the preferred embodiment of the invention the cross-sectional shape of the bar is oval or rectangular; an oval cross-sectioned bar is shown in FIGS. 1 and 2.

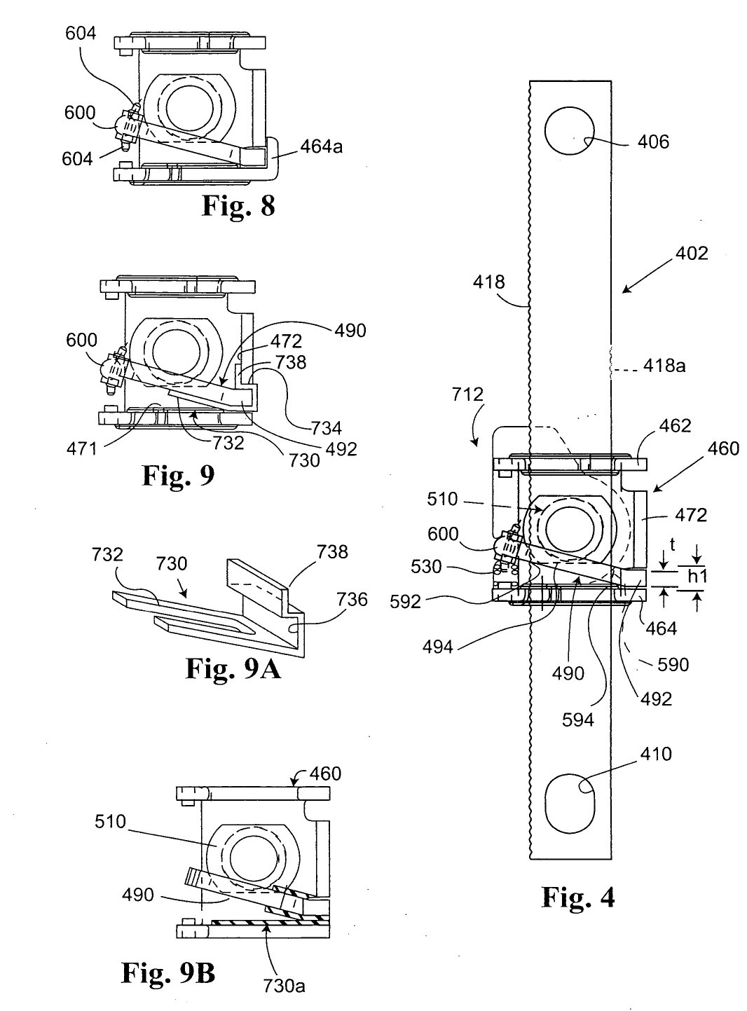

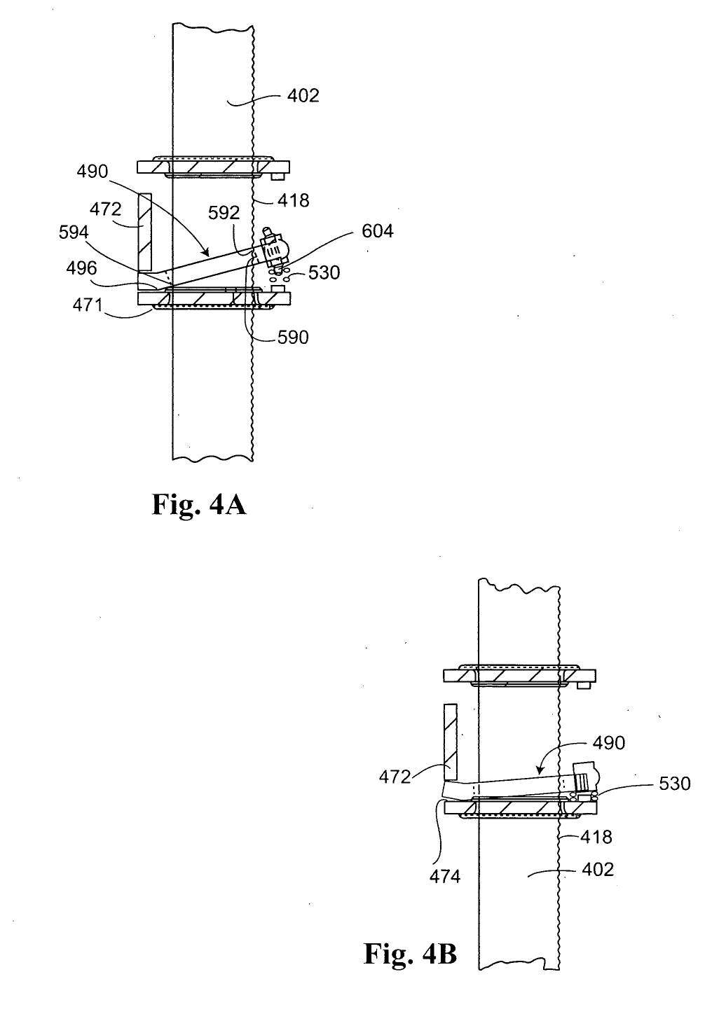

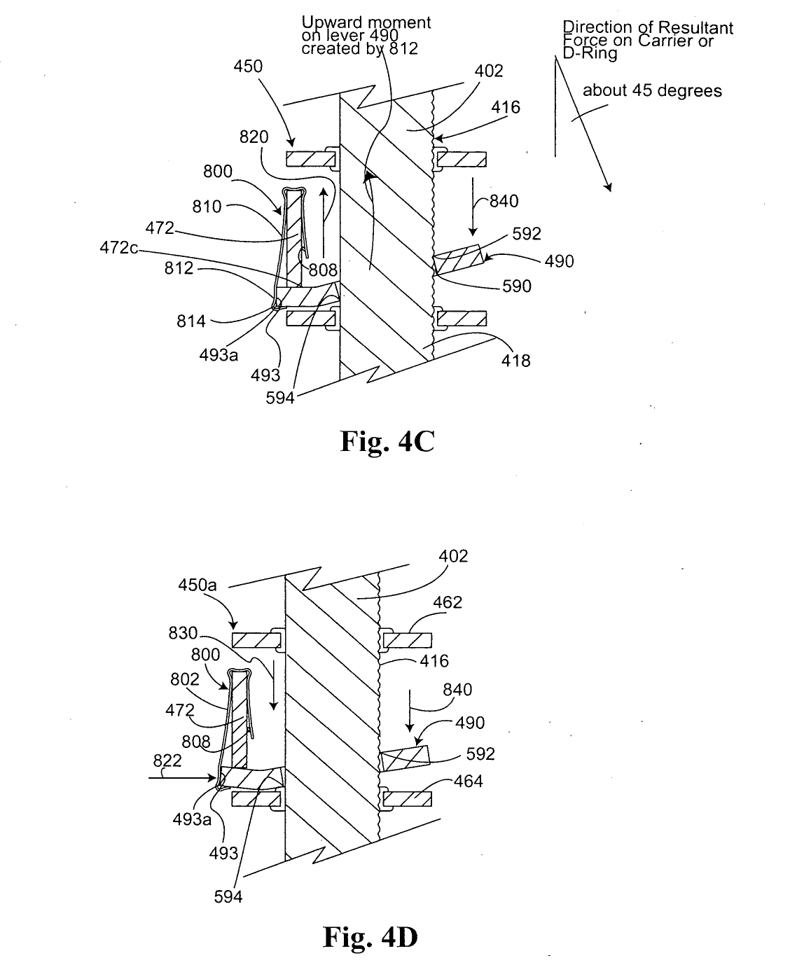

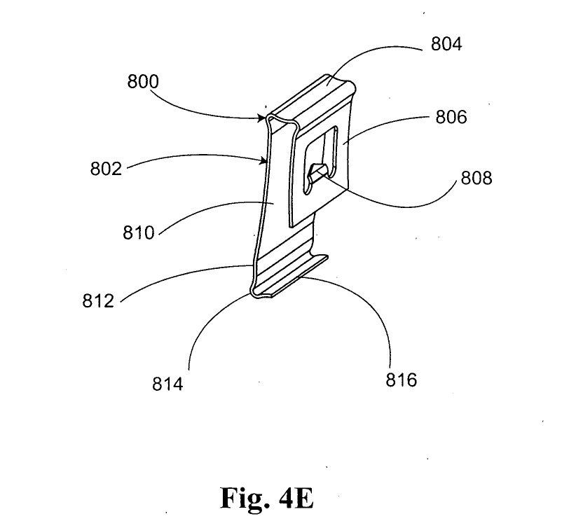

The carrier assembly 450 includes a carrier 460, a locking lever 490, a lever cap 600, a hollow, threaded fastener 510, a spring 530 or 800 (see FIG. 4C) and an activation lever 700. A D-ring 550 is secured to fastener 510 with a threaded bolt (not shown).

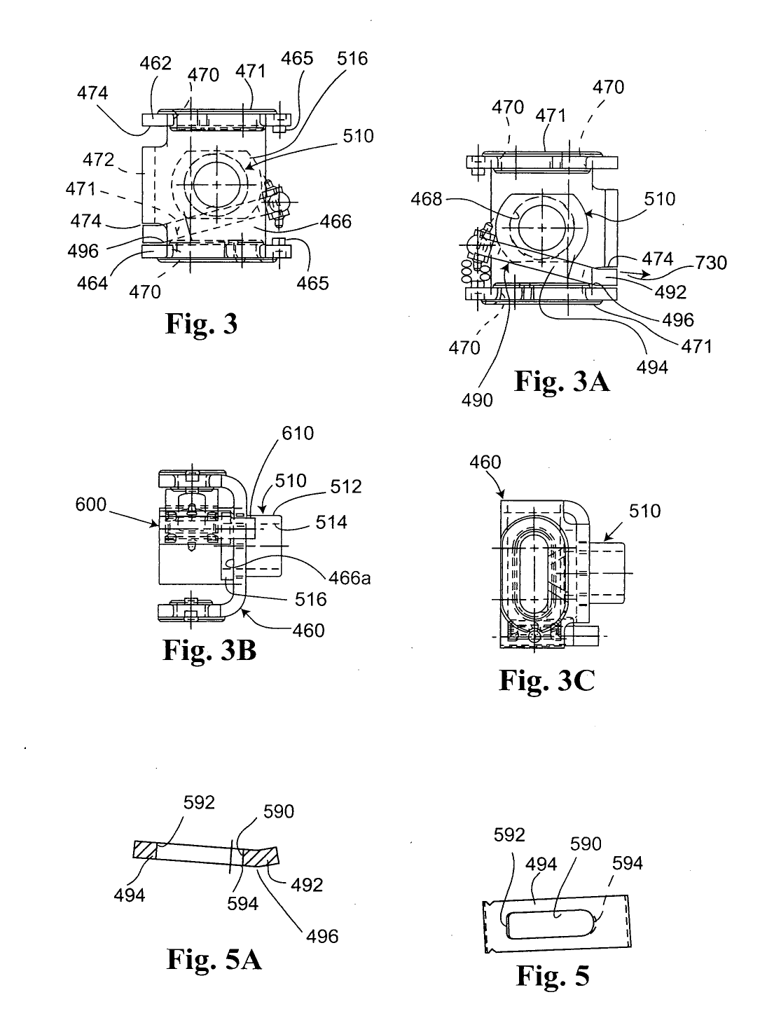

The carrier 460 is preferably made from a heat treated metal (such as steel) stamping and includes a top 462, a bottom 464 and a front wall, which is also referred to as a center wall 466. Details of the carrier 460 are also shown in FIGS. 3 and 3A-3C. The front wall 466 includes an opening 468 (see for example FIG. 3A) into which the threaded fastener 510 is secured; the fastener 510 extends outwardly from the carrier. From the various figures it can be seen the carrier 460 is generally U-shaped. Each of the top and bottom includes an aligned opening 470. As will be seen the bar 402 is slidably received through both the top and bottom openings 470. Each of the openings 470 is configured to closely envelop the four corresponding sides of the bar 402. As mentioned above the carrier 460 and the bar 402 are each made of metal. To avoid the possibility of rattle and noise, bushings 471 can be inserted within a corresponding opening 470. The bushings 471, which are hollow, insulate the carrier 460 from the bar 402 and can be made of a polymeric material (including plastic) or an appropriate metal. As can be appreciated the discrete bushings 471 can be eliminated by coating the carrier 460 with a polymeric material; the material is formed into the bushings 471.

As mentioned above, the fastener 510 is received within opening 468 of the carrier 460. Typically fastener 510 would be swaged or otherwise permanently connected to the front wall of the carrier 460. As can be seen from any of the above figures the fastener 510 includes a cylindrical body 512 defining a hollow, threaded bore 514. The fastener 510 includes the rear flange 516, which lies adjacent to a rear surface 466a of the front wall 466 of the carrier 460. A threaded bolt (not shown) for the D-ring or web guide 550 is received within bore 514. The D-ring 550, see FIG. 1, includes an opening 552 through which this threaded fastener extends. The D-ring also includes a narrow slot 554 through which the shoulder belt slides.

Reference is briefly made to the carrier top and bottom, respectively 462 and 464. At least the bottom 464 includes a projection or detent 465, which is used as a post to receive one end of the helical spring 530 (if used). The carrier 460 can also be mounted to the bar 402 in a 180 degree rotated configuration. Obviously, this rotation interchanges the location of the parts identified as the top and bottom. In order for the carrier 460 to be usable in this rotated configuration various portions of the carrier have a mirror symmetry, for example, the top 462 may also include an additional projection, detent or post 465. In general, the post 465 provides a spring retaining feature for the helical spring 530, which can also be achieved by forming a circular cylindrical recess in the bottom and/or top of the carrier 460.

The carrier 460 also includes a side (side wall) 472. As more clearly shown in FIGS. 1, 2 and 3 the side 472 integrally extends rearward from the front wall 466 and is generally oriented perpendicular to the top 462, bottom 464 and front wall 466. Additionally, each of the top 462 and bottom 464 integrally extends from the front wall 466 and is oriented generally perpendicularly thereto. As can be seen from FIG. 2 (also FIGS. 3 and 3A) the height, h, of the side 472 does not span the complete distance between the respective inner surfaces of the top 462 and bottom 464. More particularly, the side 472 and top and bottom of the carrier cooperate to provide at least one slot or space (a pivot slot) 474 therebetween. To provide symmetry, the carrier 460 includes two such slots or spaces 474 although only the lower one is used in the illustrated embodiment.

As mentioned above, the carrier assembly 450 also includes a locking lever 490. The locking lever, which is also made of heat treated steel, includes a base portion (base) 492 and a lever, lever portion or actuating arm 494, preferably of integral construction. More specifically, the lever 494 is bent upwardly relative to the base 492 at about fifteen degrees. The bend is shown by numeral 496. As can be seen from the various figures the locking lever 490 additionally includes an opening 590 through which the bar 402 extends. The material of the locking lever 490 surrounding the opening 590 is shaped to form a generally perpendicularly shaped corner or lock edge 592 at the intersection of the opening 590 and a top surface of the locking lever 490. Similarly another sharp corner or locking edge 594 is oppositely formed at the lower intersection of the side of opening 590 with an adjacent bottom surface of the locking lever.

Reference is briefly made to FIG. 4, which illustrates the locking lever 490 in its locked configuration with locking edge 592 in engagement with one of the teeth 418 of the bar 402. The bias spring 530 biases the actuating lever portion 494 (of the locking lever 490) into this locked position. Spring 800 (see FIG. 4C) will also bias the lock lever to its locked position. In this locked position the sharp corner 594 is also biased against the opposing side 414a of the bar 402. When loaded, edge 594 impinges on side 414a and adds additional load carrying capacity. The hardness of the locking lever is equal to or harder than the hardness of the bar 402. In the preferred embodiment, as mentioned above, side 414a does not include any discrete locking features such as the plurality of teeth 418, however, another set of teeth, such as 418a (a portion of which is shown in phantom line), can be formed into side 414a.

Reference is briefly made to FIGS. 4A and 4B, which respectively show a locking lever 490 in its locked position and in its rotated, free position. In the locked position, downward motion of the carrier 460 is prevented primarily due to the engagement between the locked corner 592 and a particular tooth 418 into which the corner 592 engages. When locking lever 490 is rotated downwardly ever so slightly, locking corners 592 and 594 disengage from the bar 402. This action permits the carrier 460 (and web guide and shoulder belt which are movable with the web guide) to be moved upwardly or downwardly to a new locked position, which will enable the shoulder belt to cross the occupant's body at a more comfortable orientation.

One of the benefits of the present invention attributable to having the plurality of contiguous locking features 418 extending across the operative zone of the height adjuster 400 is that the user, when moving the carrier 460 up and down, will be assured to locate the lock edge 592 in a tooth 418. This is not the case with some prior art height adjusters, which permit the corresponding locking mechanism to be repositioned between widely spaced locking features. An advantage of utilizing the plurality of contiguous locking features 418 is that when an impulsive force is applied to the web guide 550 and hence to the carrier 460, the contiguous teeth 418 do not permit the carrier to be rapidly accelerated between locking features as happens in the prior art.

As can be seen in the various figures the base 492 of the locking lever is inserted within the lower (pivot slot) space 474. The thickness, t, (see FIG. 4) of the base 492 is smaller than the height h1 of the lower space 474 to enable easy assembly of locking lever 490 to the carrier 460 and allows space for base 492 to pivot.

The carrier assembly 450 additionally includes the lever cap 600 (see for example FIGS. 1 and 2). The lever cap 600 is secured to (or molded to) the distal end 491 of the locking lever 490. As will be seen below the helical spring 530 is received upon the lever cap 600. The lever cap 600 is preferably formed as a plastic inserted molded part molded upon the locking lever 490. However, the lever cap 600 can be separately formed and attached to the locking lever 490. The lever cap 600 may include the recess 602 to receive the distal end 491 of the locking lever.

The lever cap 600 may also include one or more spring locating features 604, which cooperate with an end of spring 530 (if used) to position spring 530 properly relative to the locking lever 490 and to hold the spring to the lever. As illustrated, the lever cap 600 includes two such locating features 604 formed as posts, thereby enabling the lever cap 600 to be rotated 180 degrees relative to the locking lever and still be able to locate the spring 530. The spring locating features 604 can also be formed as a circular cylindrical recess.

The lever cap 600 includes a circular, cylindrical projection or pin 610. With the lever cap 600 on the locking lever 490 the pin 610 extends forwardly. As can be seen more clearly in FIG. 3B the pin 610 extends beyond the front surface of the front wall 466 of the carrier 460.

One of the characteristics of the above height adjuster 400 is, when locked, it will not move downward unless the lock lever 490 is manually moved to disengage the lock edge 592 from the bar 402. The height adjuster is, however, upwardly movable even if the lock lever is not manually depressed. For example, the D-ring or web guide 550 can be manually grasped and pushed upwardly; this upward force will cause the lock lever 490 to move relative to side 414. Such movement might be smooth and quiet or, in some situations, the lock lever might start to bounce causing an audible sound even if side 414 is smooth. The height adjuster can be moved upwardly even if side 414 includes a plurality of teeth 416. In this case, the lock lever will definitely bounce on the teeth causing a more audible sound.

The following embodiment eliminates or at least significantly reduces such audible sound. Reference is made to FIGS. 4C, 4D and 4E, which illustrate an alternate carrier assembly 450a. Carrier assembly 450a includes many of the elements shown in carrier assembly 450. In this embodiment spring 530 is eliminated and replaced by a force generating mechanism 800 capable of generating a primarily lateral/rotational force on a side 493 of base 492 of the lock lever 490. In the preferred embodiment this bias force generating mechanism 800 is a spring 802, shown in FIG. 4E coupled to side 472 of the carrier 450a. The spring 802 generates a determinable force level on the lock lever, which in turn controls the magnitude of the friction force generated between the lock lever and the lock bar on the non-toothed side of the rail as described below. The spring force creates a torque (see FIG. 4C) acting on the lock lever 490.

The spring 802 (see FIG. 4E), which is preferably metal, includes a top 804 formed as a U-shaped clip capable of being seated atop and about side 472 as illustrated in FIGS. 4C and 4D. One of the resilient legs 806 of the U-shaped clip includes a projection 808 formed as a thin strip of metal or a stamped projection. When the spring 802 is seated on the side 472, the projection 808 pushes against a portion of the side and assists in holding the spring to the side 472 of the carrier 450a. The spring 802 further includes an extending resilient leg 810, a lower portion 812 of which acts as a pusher engaging side 493 of the lock lever. Either the leg 810 or its lower portion 812 can be arcuately formed, enabling the lower portion 812 so that the spring force is concentrated along curved surface in contact with side 493. Further, the curved profile of spring end 812 permits end 493 of lock bar to easily move or slide relative to the spring end 812.

Reference is made to FIGS. 4C and 4D. In normal use, the weight of the D-ring 550, the weight of the seat belt placed through the D-ring and any bias force input to the D-ring or belt from a retractor rewind spring of a seat belt retractor (not shown) will tend to pull the carrier downward along a resultant force vector, which may under normal circumstances be about 45 degrees. With the spring installed on the carrier 450a, and as mentioned the lower portion 812 biases the side 493 primarily laterally/rotationally toward the lock bar 402. This engagement pushes tooth 594 into the lock bar 402 and encourages the generation of a counterclockwise friction component of force 820 (as seen in FIG. 4C or 4D) to act upon the lock lever 490, which in-turn biases the lock lever in a counterclockwise (upward) direction. This force generation will occur as the carrier, as mentioned, is typically biased downward. The tendency of the carrier to move down or any slight downward movement of the carrier 450a, in combination with the generally lateral/rotational acting bias force 822 created by the spring 802, generates the friction force 820 (in an upward direction opposite to the tendency to move downward, as shown in FIG. 4C) on the lock lever on its non-toothed side 414a in the vicinity of the tooth 594. The lateral force created by the spring 802 also creates a rotational moment or torque that acts upon the lock lever. The effect of the friction force 820 is to urge the lock lever and tooth 594 to rotate into the lock bar (counterclockwise in FIG. 4C, which is a view from the rear or backside of the lock bar). This action urges the lock tooth 592 of the lock lever into a self-activating positive locking engagement with the lock bar 402 and more particularly with a particular one of the lock teeth 418 thereof.

In the preferred construction of this embodiment, the spring 802 may include an optional bent portion 814 forming an end 816 opposite the top 804. With the spring 802 in place, the resilient bent leg 814 will also generate an upward component of force on the lock lever, causing the lock lever to tend to rotate counterclockwise (relative to FIG. 4C) about the pivot point (generally the lower surface of side 472 and more particularly the inner corner 472c) created by the pivot slot to further urge tooth or sharp edge 594 into the bar, which also urges tooth or sharp edge 592 to positively hold the lock lever in a locked condition.

If the user of the height adjuster, of which carrier 450a is a part, desires to move the height adjuster to a higher position, the user will typically grab the D-ring 550 and push same upwardly. A slight upward movement of the lock lever 490, in view of the spring bias force 822, generates a frictional force generally shown by numeral 830, acting downwardly on the lock bar 490. This friction force 830 generates a clockwise (relative to FIG. 4D) torque on the lock lever causing lock tooth 592 to disengage from the lock bar and from a corresponding lock tooth such as 418. With the lock lever disengaged from the lock bar, the lock lever will not ratchet over the teeth 418 as the carrier is moved, resulting in the quiet operation of the carrier. As can be appreciated, the user does not have to purposely release any component of the height adjuster to disengage the lock lever. The present invention provides an extremely easy and convenient way to move the D-ring to a higher location.

When the user desires to move the carrier 450a and D-ring 550 to a lower position, the lock lever 490 needs to be positively pushed downwardly as inferred by force 840 of FIG. 4D against the bias force created by spring 802.

In most installations it is unlikely the user will apply a direct force to the lock lever 490 as a lock lever will most probably be installed behind the trim panel of the vehicle. The locking lever 490 can be moved using activation lever 700 discussed below. The activation lever 700 is illustrative of various levers and buttons installed in front of the trim panel and movable with the carrier. Activation of the lever 700 or the lock lever directly moves tooth 592 from the lock bar resulting in a smooth and quiet movement to a lower position. When at the lower position, the activation lever 700, or similarly acting button or the like is released. The lateral force 522 urges the lock lever into the lock bar and causes the lock lever to self actuate, urging the lock tooth 592 into the lock bar.

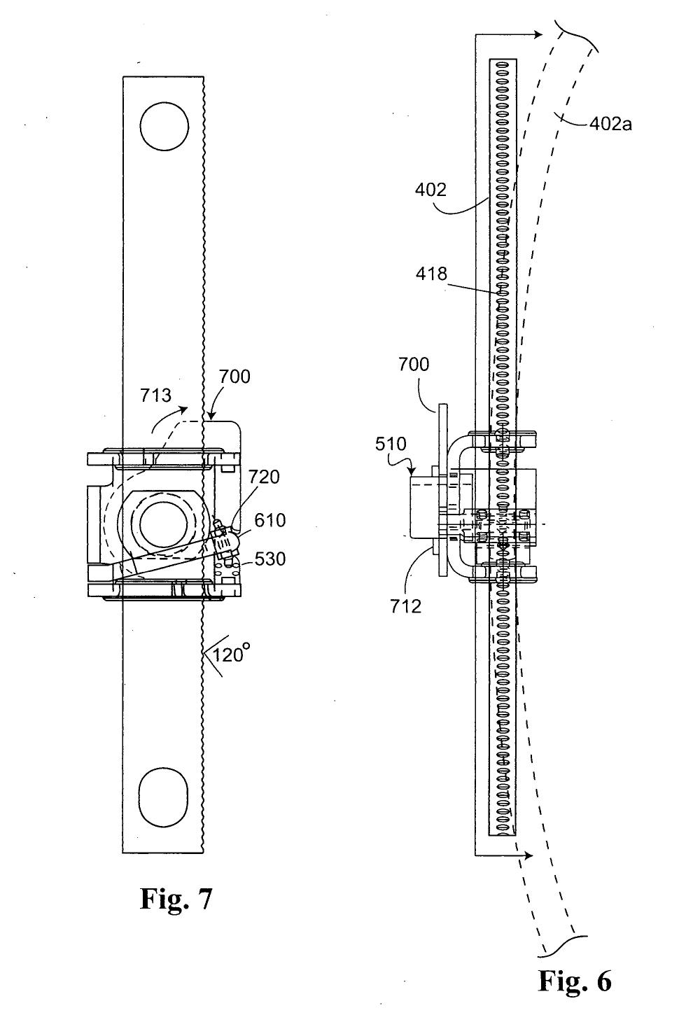

Reference is again made to FIGS. 1 and 2. The height adjuster 400 additionally includes the activation lever 700. The activation lever includes an opening 710 that is closely sized to the outside diameter of the fastener 510 thereby permitting the activation lever 700 to rotate upon the outside surface of fastener 510. The actuation lever 700 may be formed as a flat plastic molded part. As can be seen in FIG. 6 the activation lever 700 is secured to the fastener 510 using an annular lock washer 712 or similar fastener.

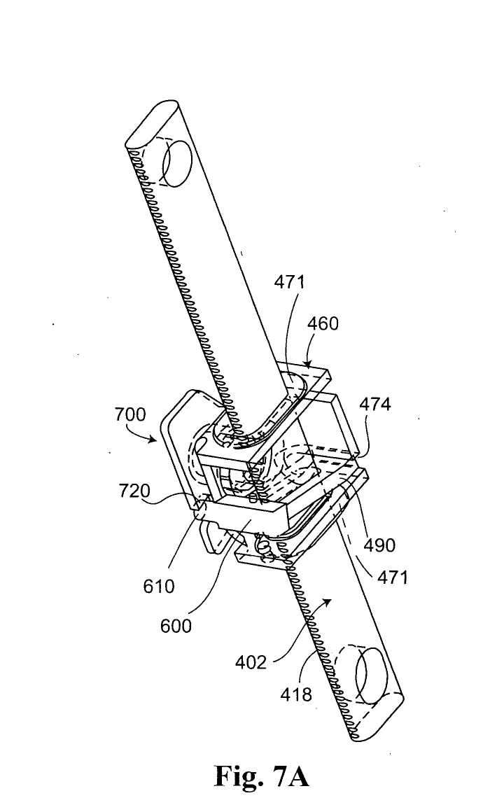

The activation lever 700 additionally includes a receiving groove 720 having a height, h_{g}, which is slightly larger than the diameter of the cylindrical post or pin 610. As shown the groove 720 is radially extending. As can be seen in FIGS. 7 and 7A pin 610 is received within groove 720. The rotation of the actuation lever 700 (see arrow 713 in FIG. 7) moves the groove 720 downwardly, which forces pin 610 and locking lever 490 down. As mentioned above, this action also compresses the bias spring 530. When the activation lever is released the bias spring 530 returns the lever 700 to its non-activated position, again locking the carrier to the bar. The downward movement, i.e. the rotation of locking lever 490, reorients the opening 590 so that the walls of the locking lever opening 590 move away from the sides 414 and 414a of the bar 402. In this position the corner or lock edge 592 has been moved away from the teeth 418 and corner 594 has also been moved from side 414a of bar 402. This position corresponds to the free or unlocked position of the height adjuster 400.

With locking lever 490 in this orientation the carrier 460 can be moved upwardly and downwardly upon the bar 402 to a new location which presumably will provide a more comfortable experience for the wearer of the seat belt.

As mentioned above the thickness of the base 492 is smaller than the height h1 of the space 474. Consequently when the lever 700 moves downwardly against the bias force of spring 530 the locking lever appears to rotate about bend 496 but also slides laterally (see numeral 730 of FIG. 3A) relative to side 472 further into opening 474. As the thickness t, of base 492 approaches the size of the opening 474 movement of locking lever approaches a more rocking or rotational motion as the tendency to slide is reduced.

Reference is briefly made to FIG. 8. As can be seen FIG. 8 is substantially identical to FIG. 3A with the exception that the carrier bottom 464 includes an upward extension 464a, which acts as a wall or stop. This wall or stop prevents the above-mentioned lateral motion of locking lever 490 through the opening 474. In this configuration the motion of locking lever 490 is generally completely rotational motion and less effort is needed to move the lever, preventing excessive wear to edge 592 of the locking lever 490.

Reference is briefly made to FIG. 9, which shows an alternate embodiment of the present invention. In this embodiment the helical spring 530 has been replaced with a leaf spring generally shown by numeral 730. The leaf spring 730 includes one or more spring metal leaves located below the locking lever to bias same clockwise in FIG. 9. In FIG. 9 a single pre-formed leaf 732 is positioned above the lower bushings 471, if used (or atop the upper surface of the carrier bottom 464) and under the surface of the locking lever 490. The leaf 732 includes an opening for receipt of the bar 402 or the leaf may be bifurcated into two spaced legs and the bar 402 positioned therebetween. The leaf provides for a balanced biased force across the lower surface of the locking lever 490. The imposition of the leaf 732 biases the base 492 of locking lever 490 upwardly generally toward a lower surface 734 of side 472. This upward bias acts to limit the lateral motion of the locking lever 490 assisting to generate friction forces, which oppose the lateral motion as the lever is depressed.

Additionally, the leaf spring 730, which is formed of spring steel, may include pocket portion 736, which is received within the lower space 474. The spring 730 may also include an extending flange or wall 738 which, as can be seen in FIG. 9, is located adjacent an inner surface of side 472. The base of the locking lever is received in this pocket portion 736. This configuration of the spring 730 with the flange also prevents the lateral movement of the locking lever as it is depressed. FIG. 9B shows the leaf spring 730a is molded about the locking lever.

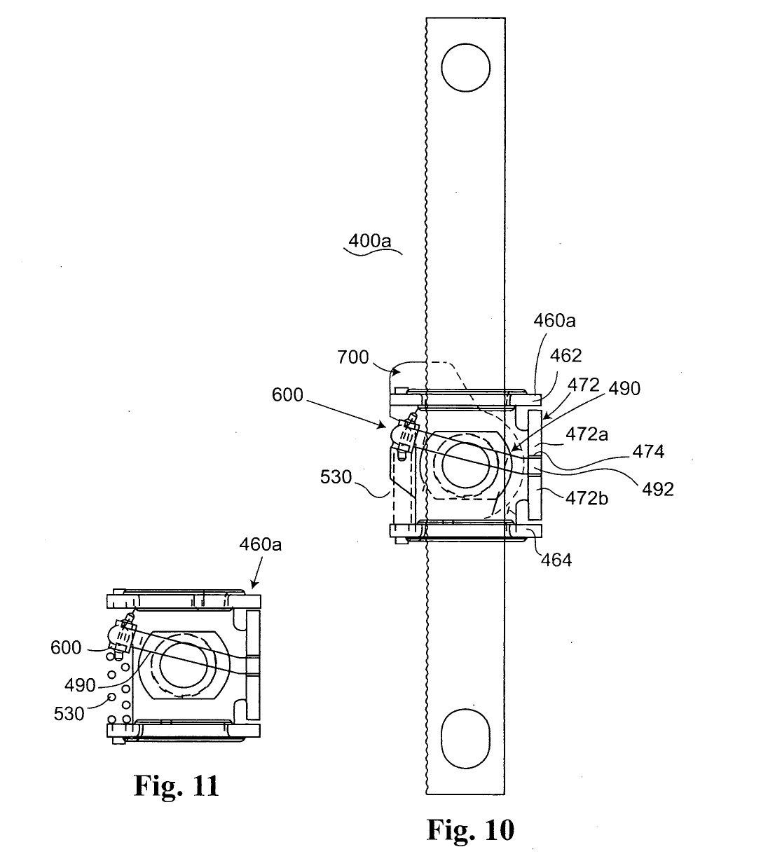

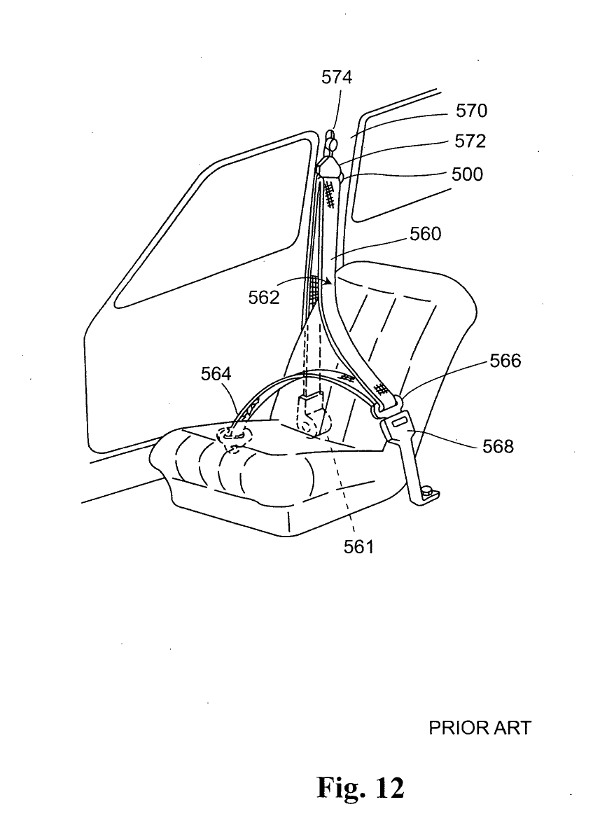

FIGS. 10 and 11 show details of an alternate embodiment of the present invention. More particularly, there is illustrated a height adjuster 400a, which includes most other parts illustrated in FIGS. 1 and 2. One of the major differences between height adjuster 400a and height adjuster 400 is the placement of the locking lever 490 relative to a carrier 460a. As can be seen in both FIGS. 10 and 11, the carrier 460a includes a modified side 472, which includes upper and lower portions 472a and 472b separated by a space 474. As in earlier embodiments, base 492 of the locking lever 490 is received in space 474. However, in this embodiment the space 474 is generally in the center of side 472 as opposed to being oriented adjacent to the bottom 464 of the carrier. In this embodiment the bend angle between the locking lever base 492 and the actuating portion 494 can be the same angle as used in the earlier embodiments, that is, approximately 15 degrees. Additionally, since the distal end 491 and lever cap 600 are located a greater distance away from the bottom 464 than in earlier embodiments, a larger spring 530 interconnects the lever cap 600 and the bottom 464 of carrier 460a. The height adjuster 400a additionally includes the activation lever 700 with the groove 720. The relative position of groove 720 upon the activation lever 700 has been changed to accommodate the new location of the lever cap 600 and its associated pin 610.

Reference is again made to FIG. 6, which shows another feature of the present invention. Numeral 402a shows an alternate bar, which is curved. As illustrated, bar 402a is convex in shape and more particularly bar 402a lies about a circle having a radius of about 7.5 inches. The carrier 460 is able to traverse curved bars, which is not the case with the prior art. The size of the openings in the top and bottom of the carrier 460 as well as the size of the openings in the bushings may have to be increased to accommodate the curved bar.

Many changes and modifications in the above-described embodiment of the invention can, of course, be carried out without departing from the scope thereof. Accordingly, that scope is intended to be limited only by the scope of the appended claims.

1. A device (100, 200, 400) for a seat belt system comprising:
a mounting bar (102, 202, 402) adapted to be mounted to a portion of a vehicle or seat, the mounting bar having at least one side wall;
a carrier (120, 220, 460, 460a) slidably mounted to the bar and movable along the bar to various positions, the carrier configured to receive the mounting bar and including a side wall (472) a bottom which is configured as a pivot;
a spring loaded, locking lever (170, 270, 490) movable within the carrier and relative to the mounting bar from a locked position to a free position, the locking lever including a base end operatively cooperating with the pivot of the carrier, the locking lever including an activation arm with a lock opening, the lock opening configured to receive and selectively lock upon the mounting bar, the locking lever including a first lock edge formed on a corner of the locking lever at the lock opening, the lock edge engagable with the mounting bar when the locking lever is in the locked position; and
a lateral force generating mechanism configured to act upon the locking lever to urge a first portion of the locking lever into the mounting bar to generate a force between that portion of the locking lever and the mounting bar to urge the lock lever in a direction to self-lock with the mounting bar when the carrier is urged downwardly by applied forces and to decouple with the mounting bar when the carrier is urged upwardly.

2. The device according to claim 1 wherein the lateral force generating mechanism a spring 802 secured to a top of the sidewall and includes a resilient leg 810 in contact with a side of the lock lever to urge the lock lever laterally into the mounting bar.

3. The device according to claim 1 wherein the resilient leg 810 of the spring 802 includes a hook-like portion 814 engagably with the end of the lock lever to biasing the end of the lock lever in a direction which urges the first portion toward engagement with the mounting bar.

4. The device according to claim 3 wherein the carrier includes a front face configured to receive a web guide for a shoulder belt of a seat belt system.

5. The device according to claim 3 wherein a lower portion (812) of the leg 810 is arcuately shaped.

6. A height adjuster (100, 200, 400) for a seat belt system comprising:
a mounting bar (102, 202, 402) adapted to be mounted to a portion of a vehicle or seat, the mounting bar having at least one side wall;
a carrier (120, 220, 460, 460a) slidably mounted to the bar and movable along the bar to various positions, the carrier being generally U-shaped in cross-section and having a top and bottom wall and a center or front wall, the top and bottom wall each including a first opening through which the mounting bar extends;
a spring loaded, locking lever (170, 270, 490) movable from a locked position to a free position, the locking lever including a base end operatively cooperating with a portion of the carrier,
the locking lever including an activation arm with a lock opening extending the activation arm, the lock opening configured to receive the mounting bar, the locking lever including a first lock edge formed on a corner of the locking lever at the lock opening, the lock edge engagable with the mounting bar when the locking lever is in the locked position;
the locking lever being biased to the locked position by a bias spring, and when the locking lever is in the free position the first lock edge is disengaged from the mounting bar and
a lateral force generating mechanism configured to act upon the locking lever to urge a portion of the locking lever into the mounting bar to generate a friction force between the portion of the locking lever and the mounting bar to urge the lock lever in a direction to self-lock with the mounting bar when the carrier is urged downwardly and to decouple with the mounting bar when the carrier is urged upwardly.
